(19) United States
(12) Patent Application Publication
(10) Pub. No.: US 2004/0155516 A1
(43) Pub. Date: Aug. 12, 2004

(54) Vehicle tire pressure control system and process

(75) Inventors: Rafael Antonio Colussi, Santa Fe (AR); Nestor Juan Venica, Santa Fe (AR)

Correspondence Address: DAVIDSON, DAVIDSON & KAPPEL, LLC, 485 SEVENTH AVENUE, 14TH FLOOR, NEW YORK, NY, 10018, US

(73) Assignee: Col-Ven S.A., Guadalupe Norte (AR)

(21) Appl. No.: 10/677,965

(22) Filed: Oct. 2, 2003

(30) Foreign Application Priority Data
Oct. 8, 2002 (AR) P02/01/03787

(51) Int. Cl. B60C 29/02

(52) U.S. Cl. 301/5.24

(57) ABSTRACT

A rotary pneumatic coupling (25) is disclosed, in which the vehicle axle (19) is used as a support for the installation piping. The coupling shaft (49) has an end formed as a nozzle projecting towards the wheel plane and arranged as an axial extension of the vehicle axle end. The shaft is rotatably and slideably supported by a pair of ball bearings (47) inside a block (35-37) secured to the wheel hub cap (39). The internal shaft conduit (51) leads to a chamber (45) having ports for connection to the tires after passing through the respective chamber valve. The shaft abuts against an axially movable plug (57) closing the chamber and having an axial hole as an extension of that conduit. An axial shift of the shaft relative to the plug opens the chamber to a vent port (65). This situation causes a status indicator light (27) to light up in the panel of a control module provided in the trailer within the field of view of the rear-view mirror (33). Methods for detecting wheel bearing faults use this coupling when the axial shift of the shaft is sufficient to vent pressurized air or to cut is the cover. Another embodiment discloses a shorter shaft making the coupling (25′) more compact such that it stands out less from the vehicle. Different methods are used to arrange an air duct inside the hollow axle according to features thereof. The system is comprised of two rotary couplings in both ends of the axle and a pneumatic tube installed inside the axle and connecting to the air supply system through its middle portion.

### FIELD OF THE INVENTION

The present invention provides a leaktight passage of fluid through the rotation axis between two mechanical parts of a motor vehicle having relative rotational motion, in particular where one of the parts is a wheel of the vehicle which may in addition be subjected to other types of motion such as vibrations. This invention relates more particularly to rotary couplings to be mounted to a motor vehicle's wheels, including in particular its trailer, to convey pressurized air between the wheel tires, and an air-operated system provided in the vehicle to control and adjust the tire pressure and to compensate any possible small losses by supplying air from a compressed air source, typically a compressor belonging to such system or by making the tire pressure suitable to changing road paving or ground conditions.

This invention also relates to methods for installation of the coupling on different types of axle ends and a tire inflation pressure control system provided in the trailer of a truck or any other analogous type of means of transport.

### BACKGROUND OF THE INVENTION

In large and medium-sized vehicles, whether passenger or cargo, it is of particular importance to control the pressure of the tires whilst on the road, considering the serious consequences an accident, caused by an inappropriately inflated tire, happening when traveling at high speed and/or when other vehicles are on the road. For some years now the rule is to install in these vehicles tire inflation pressure control and compensation systems, which include an air line coupled to the tire inflation valve and use the onboard brake system compressor to correct deficiencies detected in the air pressure of the tires, as well as a control module located in the cab's instrument board.

The use of rotary couplings in this piping to ensure the leaktight rotational motion of the wheel to be controlled, relative to the chassis or static part of the vehicle, is well known. The static installation typically includes a section of piping fastened to the body of the vehicle, usually to a vehicle's fender, which is axially coupled to the outer end of the rotary coupling fastened to the wheel hub. Argentine patents 231,948 and 246,394 disclose rotary couplings in which the air connection to the static part is provided by the outer end of the coupling shaft or rotor. The term “outer” is used herein in relation to the vehicle's chassis or body, that is the connection is provided on the outer side of the wheel, for example using a piping of the type disclosed in patent application P96-01-05973.

This system is of relative simplicity and does not affect mounting of the wheel on the axle's end but, as a drawback, the sealed connection and coupling are exposed to hitting against road curbs or other hard objects or to damages arising from slight accidents or contact with other vehicles, which may render useless the system on the wheel in question, as well as to any vibrations of the vehicle in motion, the movement of the tire axle suspension relative to the vehicle's body, weather conditions, the contact with air, which subject the system to mechanical, thermal and dynamic stresses of different degrees and oscillations which may affect the useful life of the system, as disclosed for example in Argentine patent application P970105,633.

Also known in the art is the “Meritor” system from Pressure Systems International, Inc. (USA), U.S. Pat. No. 5,584,949, which makes use of the hollow axle that most North American and European automobile brands use for mounting the wheels, using the inside of the axle as a part of the system's air conveying piping. This system has the advantage of not exposing the pipe and rotary coupling as in the other case but, because of using the inside of the axle as an air chamber or duct, the end covers should be reprocessed to work as leaktight covers. Any possible leaktightness defect may pressurize the axle end, thus damaging the original seals. In addition, the “Meritor” system has other drawbacks, such as that small air leaks overpressurize the tire assembly bearing compartment in the vehicle's axle end. Such overpressure damages the bearing seals and drives the lubricating grease out of them, thus reducing its useful life. This situation worsens when the rotary coupling's seals wear out, which is generally detected only after some time when the leakage reaches a certain magnitude, thus forcing the vehicle's bearings to run dry and even break.

Finally, U.S. Pat. No. 6,325,124 to Colussi and Venica includes a coupling for the same purpose as this invention, that is for the connection “inwards” into the axle, and also discloses a method for preventing catastrophic faults in wheel mounting on the vehicle's axle end, by detecting wheel bearing wear or breaking.

In addition, for installing such systems in trailers, the location of the control module in the truck cab's dashboard requires laying a piping between the trailer and the truck in order to convey air to the pressure gages, pressostats, warning lights and control elements mounted on the panel.

### SUMMARY OF THE INVENTION

The present invention not only solves the problem of the loss of lubrication in the wheel's bearings due to overpressure from the rotary coupling, but also enables one to diagnose a shift in the bearings travel, due to wearing, breakage or fault of any of its components.

Therefore, an object of the invention is to provide a rotary pneumatic coupling for one or more wheels located on a vehicle's axle end, wherein the vehicle axle is used as a support for the pipe section of the static installation connected to the rotary coupling, which shaft is connected inwards into the vehicle's axle.

Another object of the invention is to provide a coupling as defined in the preceding paragraph, but the construction of which avoids exposing the wheel bearings to air overpressures from the coupling.

Yet another object of the invention is to provide a method for installing and connecting the coupling from inside the wheel axle, thus avoiding having to reprocess the axle end covers to make them leaktight, by means of techniques tailored to different types of axles: solid, semisolid and hollow, by passing a tube through as a guide for passing the piping inside the wheel axle.

These and other objects and advantages of the present invention which may become apparent in the following detailed description are accomplished by providing a rotary pneumatic coupling comprising a block mounted on the wheel axle end (or on the wheel tandem end, as the case may be) and inside which a pressurized air chamber is formed, linked to the wheel tire through one or more orifices in the block. In the case of axles with two or more wheels, the block may have as many orifices connecting to the inner chamber as tires to be controlled. The block houses a rotary shaft through which a conduit passes leading into the chamber and a rotating seal to prevent, under normal operating conditions, pressurized air from leaking from the chamber through the interstitial gap between the shaft and the block. According to the invention, the coupling's shaft has an end extending from said block to the wheel's plane, provided with a nozzle or a connecting device to a pressurized air conduit passing through the vehicle's axle to connect the chamber to the air pressure control device through the said conduit. Advantageously, the connecting device is placed as an axial extension of the vehicle's axle end. In addition, a vent port has been provided in the coupling block to depressurize the seal side opposite to the chamber, in order to protect the wheel's bearings.

The coupling's rotary shaft is mounted inside the block by means of bearings, preferably a couple of ball bearings arranged in such a way that the coupling's static shaft conduit leads, through a rotary plug, into the chamber connecting to the orifices. Under normal operating conditions, the plug avoids any pressurized air leak to the outside.

According to another aspect of the invention, the air system includes a connection for the coupling, to insert a tube into the axle. The inside of the axle is used to vent the axle end bearing oil chamber and the axle end covers are used without any reprocessing as a support for the connecting nipple of the tube conveying air to the tires. This is therefore a simple and reliable process to install a tube protected by the inside of the axle, through which tube air is conveyed to the tires. Slots and labyrinths are provided on the outside of the tube to vent the axle end oil chamber, through the inside of the axle and toward the outside.

The installation of the piping inside the wheel axle is made by means of a specially developed automatic hydropneumatic drilling machine and using specially developed connectors practically allowing to create the air connection inside the wheel axle between the air supply network and the coupling. In addition, the connectors allow ventilation of the wheel bearing compartment air chamber to the outside, since the original orifice in the wheel cover is suppressed when installing the rotor. Those vents have labyrinths for preventing water or foreign bodies from entering the axle.

According to another accessory feature of the invention, the control module containing the system operation warning lights is mounted on the trailer or on a frame thereof, whether belonging to it or fitted for such purpose, such that the module provided with the warning lights is located within the field of view of a cab's rear-view mirror.

In a further embodiment of the invention, a compact construction is developped for the rotary coupling to reduce its esposition on the sides of the truck.

### BRIEF DESCRIPTION OF THE DRAWINGS

The above and other features and advantages of the invention and the way it can be developed and practiced will be better understood upon consideration of the following detailed description of a preferred illustrative embodiment of the invention, taken in conjunction with the accompanying drawings, in which:

FIG. 1 is a schematic view of a pneumatic control system for a motor vehicle according to the present invention.

FIG. 2 is a side view of a truck with trailer schematically showing the installation of the control module for the control system of FIG. 1, according to an aspect of the present invention.

FIG. 3 is a longitudinal sectional view of a solid-end half-axle in which a connection has been installed according to an embodiment of the present invention to convey pressurized air from the tank or reservoir of the control system of FIG. 1 to a coupling as shown in FIG. 8.

FIGS. 4A, 4B, (longitudinal sectional views) and 4C (cross-sectional view) are enlarged views of the connections of the axle of FIG. 3.

FIG. 5 is a longitudinal sectional view of a hollow-end half-axle in which a connection has been installed according to an embodiment of the present invention to convey pressurized air from the tank or reservoir of the control system of FIG. 1 to a coupling as shown in FIG. 8.

FIGS. 6A and 6B are enlarged views of the connections of the axle of FIG. 5.

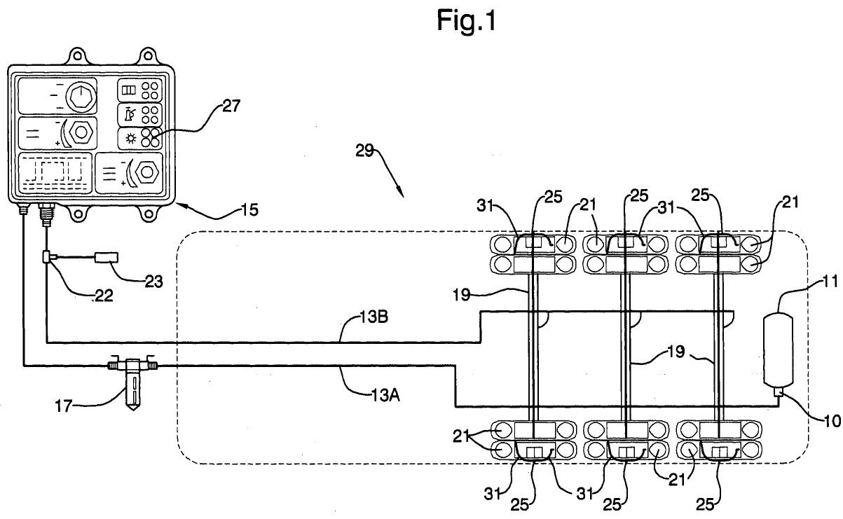

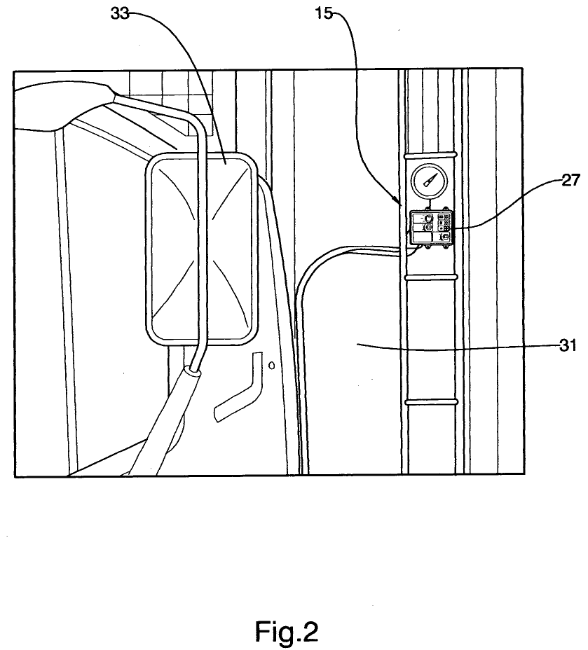

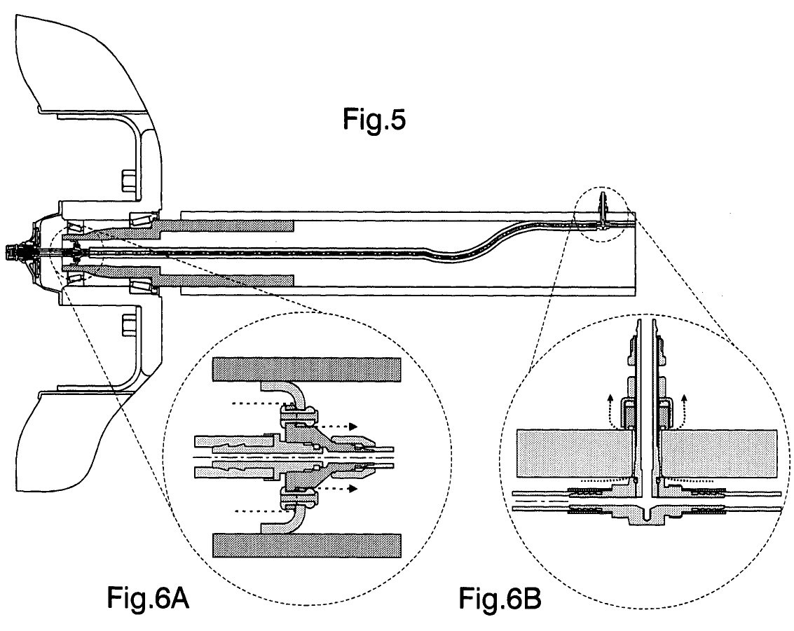

FIG. 5 is a longitudinal sectional view of a semisolid-end half-axle in which a connection has been installed according to an embodiment of the present invention to convey pressurized air from the tank or reservoir of the control system of FIG. 1 to a coupling as shown in FIG. 8.

FIG. 8 is an axial sectional view of a rotary coupling of the system of FIG. 1, according to a first embodiment of the present invention.

FIG. 9 is an axial sectional view of an alternative cover for the coupling of FIG. 8.

FIGS. 10A and 10B are longitudinal sectional views of the coupling of FIG. 8, depicted in two fault-indicating end positions

FIG. 11 is an axial sectional view of a rotary coupling of the system of FIG. 1, according to a second embodiment of the present invention.

FIG. 12 is an axial sectional view showing the mounting a rotary coupling of FIG. 8 or 11 to the end of a vehicle axle.

### PREFERRED EMBODIMENTS OF THE INVENTION

FIG. 1 shows a pneumatic control system for a motor transport vehicle such as a truck with trailer or semitrailer. The pressurized air comes from a tank 11, desirably an auxiliary tank supplied by a compressor also used for the brake circuit, provided in the trailer and connected by means of a pneumatic pipe 13A to a control module 15 controlling air supply to the wheel tires 21 by means of a second pipe. 13B. The second pipe 13B comprises conduits respectively coupled to the axles 19 of the trailer 29, while the control module concentrates all the system operation and indications to the driver and is provided with conventional means such as adjustable pressostats, electrovalves, etc. to selectively connect pipe 13A of tank 11 to the respective pipe 13B of wheel 21 in question, in response to a pressure signal.

A check valve 16 to automatically close air flow to the tires 21, when a leak exists greater than compensated by the compressor, and an air filter 17 are inserted in that pipe 13A. Filter 17 is placed in a suitable location accessible for periodical cleaning operations. The stop valve 16 may be located in place of some of the factory original plugs provided with the compressor's tank 11. An inflating valve 23 placed in an accessible location is added to the second pipe 13B by means of a T connection 22 in order to check the pressure in tires 21. This inflating valve 23 may be used during pressure calibration of the system to connect all required instruments such as a pressure gage.

Each end of each of axles 19 of the vehicle 29 is provided with a rotary coupling 25 providing a leaktight rotary connection through which air from tank 11 is redistributed by module 15 to tires 21. For this purpose, the valve of each tire 21 is respectively connected to a coupling 25 in that axle end by means of a reinforced rubber and cloth tube 31, similar to that disclosed in Argentine patent application P960105.973. Coupling 25 provides a continuous leaktight connection between pipe 13B and nozzles 19, thus resolving the issue of the relative motion between them as a result of rotation of tire 21. In the case of tandem wheels, both tubes 31 are positioned in a diametrically opposed configuration for a better dynamic balancing of tires 21.

The control module 15 is provided on an external portion of trailer 29, such that its panel, provided with indicator lights 27 indicating the status of the system, that is the inflation status of tires 21, is within the field of view of a rear-view mirror 33 in the cab, as schematically shown in FIG. 2. In such trailers 29 that, because of their nature, such as tankers, do not have any flat surfaces, the need may exist to mount a frame specifically intended to support module 15. In any case, when installing module 15, care should be taken to prevent it from projecting outwards, for better protection.

In particular, for each axle 19, indicator lights 27 comprise a red light 27R, a yellow light 27A and a green light 27R, each materialized by means of a light-emitting diode (LED) of the respective color. In the case illustrated, module 15 may control four axles 19, such that four red lights 27R, four yellow lights 27A and four green lights 27V are gathered in its panel. Each green light 27V indicates normal operation, that is the tires maintain their adjustd pressure. The red light indicates low air pressure in tank 11, in which case stop valve 16 is automatically closed by control module 15, thus disconnecting tires from pressurized air supply until a pressure sensor in the module indicates that tank 11 has recovered its operating pressure. A yellow light 27A is used to signal various fault codes in some axle 19, indicating that the system is inflating a tire 21 of the respective axle 19. Thus, if light 27A flickers intermittently, the driver may keep rolling. In the event of yellow light 27A being continuously on, the driver should stop the vehicle to repair the loss. Even worse, if light 27A flickers alternately with red light 27R, this means that the tire is very damaged and the driver must stop the vehicle immediately.

Power supply may be taken for example from the anti-lock brakes system (ABS) or from side marker lights.

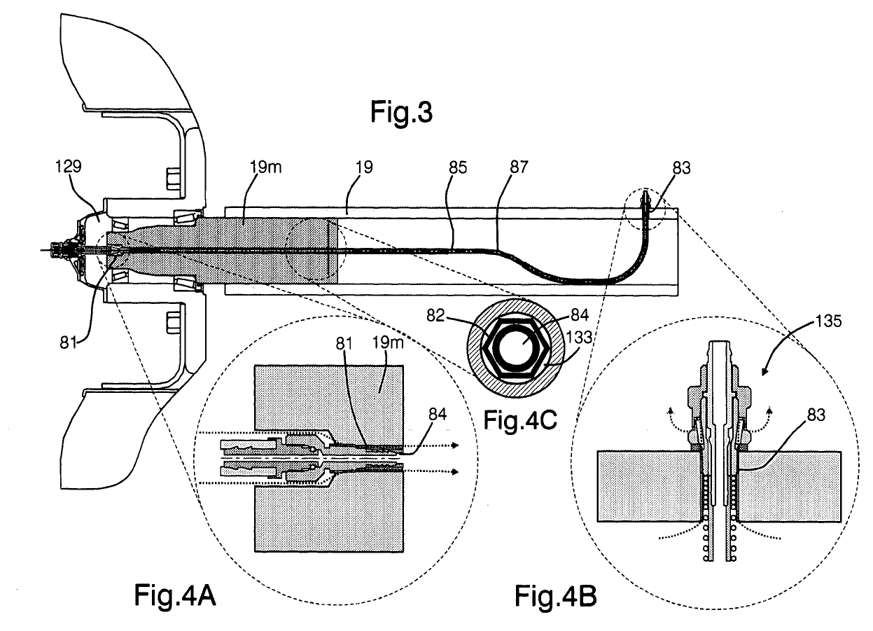

The embodiment of the inner conduit in axle 19 depends on the type of axle in the factory-run vehicle. FIGS. 3 to 9 show the installation of suitable connections for a rotary coupling 25 (as that described below in conjunction with FIG. 8) in different types of half-axles which are characteristic of this type of vehicles. These half-axles may be hollow, solid and half-hollow, that is hollow but having an internal reinforcement. Factory manuals contain further details of end axle drilling in each case.

An axle 19 having a 35 to 50 cm long solid axle end 19M at each end is shown in FIG. 3. FIGS. 4A and 4B respectively show enlarged views of axle end 19M to which the rotary coupling is attached, and of the central point of axle 19 which receives the air intake from the control system of FIG. 1, while FIG. 4C shows a cross-sectional view of the solid axle end 19M

As shown in FIGS. 3 and 4A, a thread 81 is made using a ⅛″×27 NPT tap, taking care of using a tap centering device such that thread 81 intended for fastening the rotary coupling 25 shaft is centered. As shown in FIGS. 3 and 4B, threads are made in the holes 83 located in the rear portion of axle 19, using 11×1.00 threads, and an hexagonal tube 82 is placed in such holes 83. In addition, a ¼″ diameter polyamide tube 84 to be used as an air duct is fitted inside such tube 82, as also shown in FIG. 4C. The outer tube 82 is provided to protect the inner tube 84 such that contact of the polyamide tube 84 with the inner walls of axle 19 solid portion 19M, as a result of axle movements when the vehicle is in motion, is prevented from wearing down the polyamide tube 84. The hexagonal design of tube 82 prevents friction between the Teflon hose 84 and the walls of the hole drilled in the solid end of the axle 19. The hexagonal shape takes up any size differences existing in this area. Polyamide is chosen because of its good wear properties.

A 4-mm diameter brass tube 85, which will be used as a guide to pass the air duct inside axle 19, is passed through a straight copper tube 87, a through tube 89 is inserted through one of the holes 83 and the straight copper tube 87 housing the final tube 85 is inserted through the threaded hole 81 in the end 19M, such that it is engaged by through tube 89.

Through tube 89 is pulled outwards to draw the final tube 85 outwards through hole 83, and from the other side the copper tube 87 is pulled out through hole 81, taking care not to remove tube 85 housed therein. Then, the end of this tube 85 is attached to the end of the Teflon tube 84 by means of a special straight connector 91 and a non-constant diameter protecting spring 93 is provided projecting about 3 mm outwards, such that the minor diameter of spring 93 remains in the outside.

A NPT-type coupling 95 is placed in the thread 83, turning the whole assembly to tighten, and the polyamide tube 84 is cut at about 75 mm from the axle orifice. A washer 97 and the 11×1.00 coupling 95, then a steel nipple are provided, spring 93 is turned to abut against coupling 95 and coupling 95 is tightened against axle 19.

Same method is followed for the other end of axle 19, another coupling is placed in the remaining threaded hole 81. Two 5/16″ (8 mm) diameter tubes 13B are connected to the connectors and are joined together with helical tape up to the top.

Connector 73 in the end of hose 71 attached to shaft 49 of coupling 25 is screwed into hole 81, with a star-shaped washer 103 fitted as shown in FIG. 3.

If the wheel axle is a longitudinally hollow axle 19H, that is without any internal reinforcement, a 10-mm diameter hole 109 is drilled in the rear portion and in the middle of the axle by means of a magnetic drilling machine, and a long tube 111 is passed through from end to end inside axle 19H, as shown in FIG. 5. An unthreaded end of the ¼″ diameter polyamide tube 84 is inserted into the long tube 111, and the short tube threaded end is screwed into the polyamide tube 84.

The whole assembly is pushed inwards such that the threaded orifice of connector 113 is directed towards hole 109 drilled in the axle. A stem 115 is inserted through the latter hole 109 and screwed into the orifice of connector 113, as shown in FIG. 7A. The straight connector 117 is placed in stem 115 and manually screwed into internal connector 113. Stem 115 is removed and a lock nut 119 is tightened so as to secure internal connector 113 against inner wall 121 of axle 19H.

The polyamide tube 84 is cut at about 7 cm from plug 123 hole in the end of axle 19H and the polyamide tube 84 is protected with helical tape, as shown in FIG. 7B. Coupling 25 is then connected and the whole assembly is inserted to abut against plug 123, which is drilled by means of a 4-mm diameter drill bit, using the two orifices provided in the coupling as a guide, and riveting is performed.

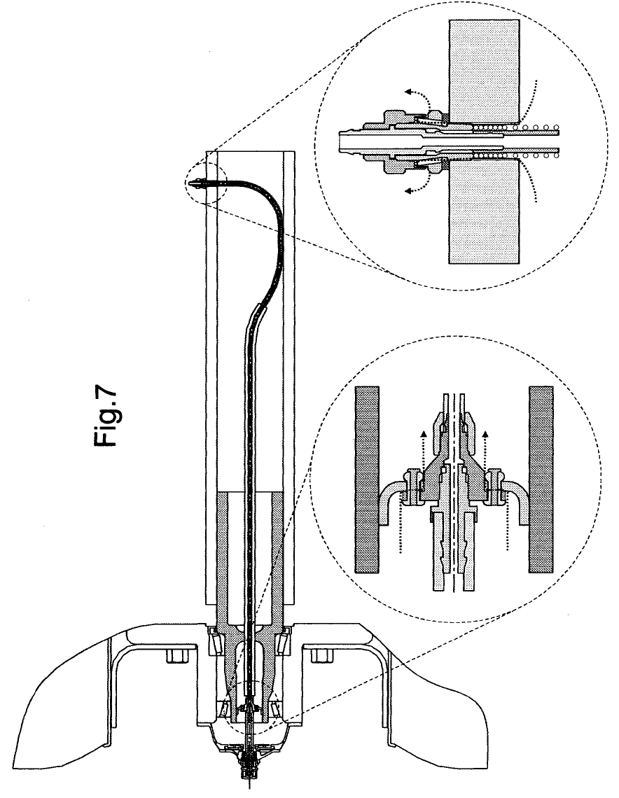

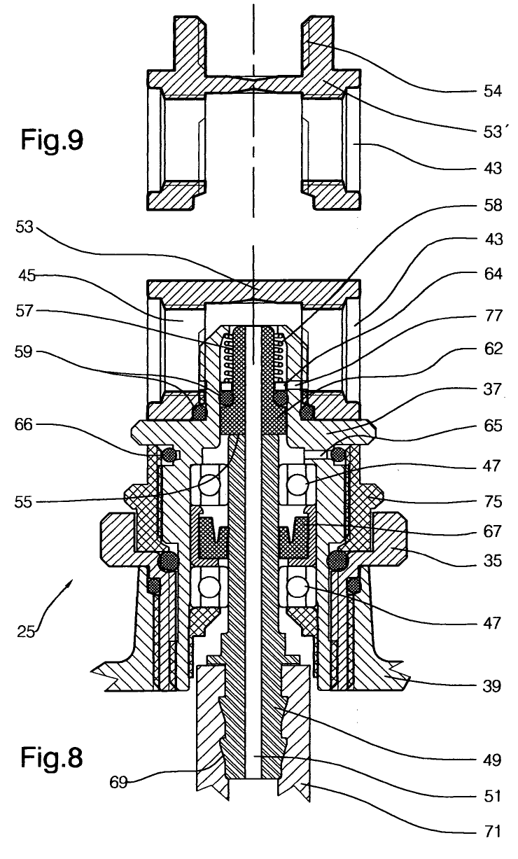

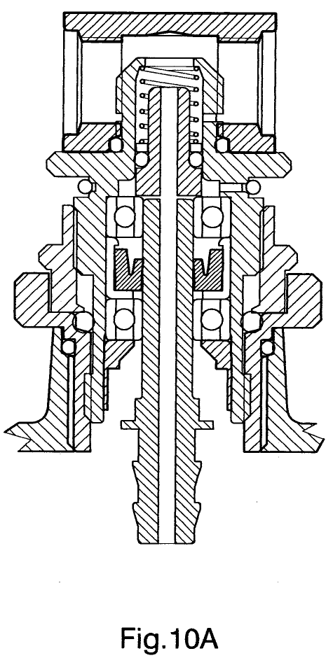

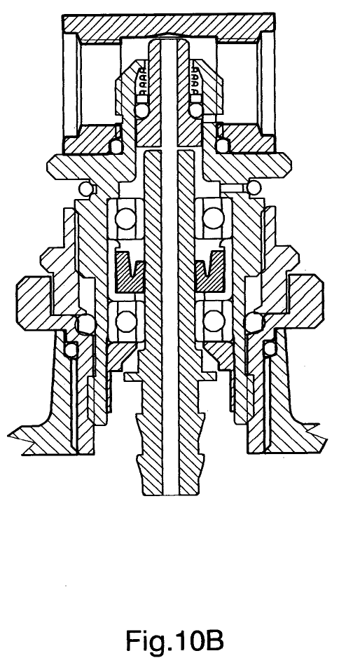

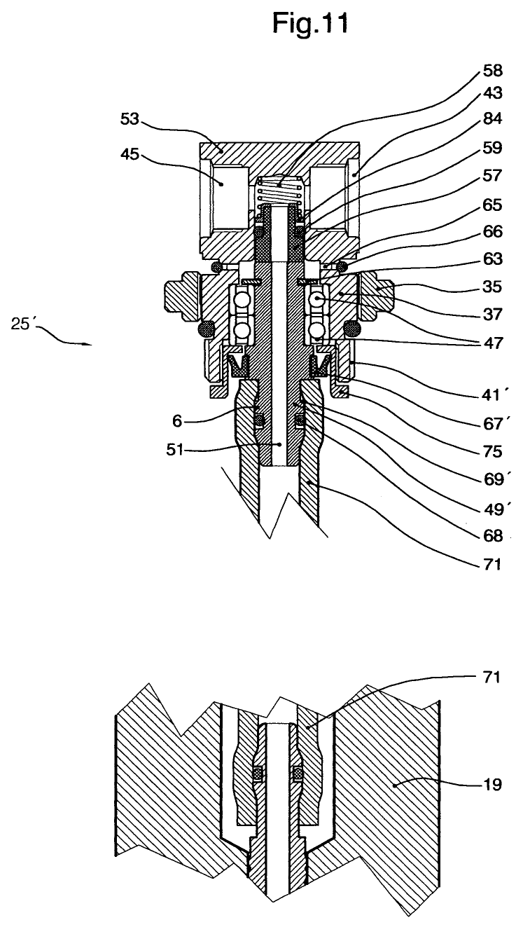

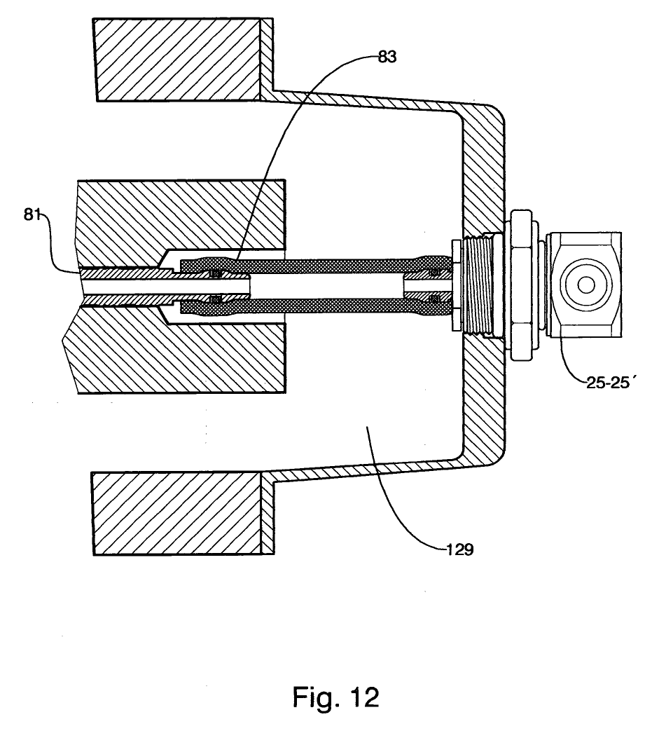

For an installation in an axle 19 hollow end having an internal reinforcement 105, as shown in FIG. 7, a 10×1.50 thread rivet 107 is placed in the end plug and riveted as shown in FIG. 6A. The method depicted in FIG. 4B is then followed.

In all three installations of FIGS. 3, 5 and 7, when coupling 25 turns as a result of contact with the air, heat is generated in oil chamber 129. Oil expands, therefore causing the internal pressure in chamber 129 to increase. Since coupling 25 now covers the grease cup, this invention provides a vent port indicated with a dash line in FIGS. 4A, 4B, 6A and 6C to relief overpressure in chamber 129.

Pressure generated in chamber 129 passes through a channel to drill hole 81 drilled in the end of axle 19, to reach the inside 131 of axle 19. In the case of solid end 19M, air flows through gaps 133 between the axle 19 wall and the hexagonal protection 82, as shown in FIG. 4C. The inside 131 of axle 19 operates as a chamber for transfering said pressure to the atmosphere through nipple 135 in the central connection of axle 19. The path described forms a labyrinthine system preventing water and dust from entering the oil chamber 129.

A first embodiment of coupling 25 is shown in FIG. 8. Coupling 25 comprises a block 37 screw onto an adjusting member 35 which in turn has an outer thread 41 for attachment to a hub cap 39 of the wheel 21. The thread 41 of the support member 35 is relatively long to permit appropriate adjustment of the axial position of the block 37 and therefore of coupling 25 assembly, relative to wheel 21. A nut 75 is screwed onto the block 37 and tightened against the support member 35 to keep the position locked, thus preventing assembly 35-37 integrally rotating with the wheel hub from loosening.

In practice, adjustment members 35 of different shapes may be provided to fit different types of hubs of vehicle axles 19.

Block 37 outer end is screw closed by a cover 53 inside which a transfer chamber 45 is formed. The cover is a plastic member in which side holes have been formed forming inlets 43 to which pipes 27 linking tires 21 are connected. FIG. 9 shows an alternative cover 53′ having a thread 54, provided to place an odometer (not shown), which assembly and functionality is the same as for cover 53 depicted in FIG. 8.

Returning now to FIG. 8, the block 37 is rotatably mounted around a shaft 49 by means of a pair of ball bearings 47. The inner end of the shaft 49 of the coupling 25 is provided with teeth 69 for axial connection to the end of a hose 71, the other end of which, that is the inner end, has a threaded connector to connect the hose to the internal conduit of the wheel's axle 19. This flexible connection 71 enables axial eccentricities and misalignments in coupling 25 mounting relative to the wheel's axle 19 to be tolerated.

An air duct 51 longitudinally traverses the shaft 49 and continues into an extension 57 prior to the chamber 45, from where it extends directly to the outlet ports 43. The extension member 57 may be made of Teflon, graphite and coke, or also of Teflon with molybdenum bisulphide and glass, having a cylindrical head 62 housed with a 0.2 mm play in the block 37. Leaktightness of the chamber 45 inwards into the wheel is protected by an O-ring type seal ring 59 sized to support all air pressure to tires 17, such that the extension 57 works as a kind of plug for the chamber 45, replacing the traditional rubber seals.

A spring 58 stresses through a washer 84 the head 62 of the extension 57, in the direction of the shaft 49, abutting against the latter's end 55 and thus sealing any contact of pressurized air with the vent port 65 under normal operating conditions. The plug extension 57 rotates integrally with the block 37 and against the outer end of stationary shaft 49. In the event of any wear or fault of seal ring 59, pressurized air will leak through a vent port 65 radially provided in block member 37, thus allowing to warn about the end of the useful life of the seal 59 without affecting lubrication of the bearings 17.

The block member 37 is adjustably fixed to support member 35 by means of the thread 41. Lock nut 75 may also be used to secure position and then adjust the axial position of shaft 49 such that its end 55 abuts against the head of plug 57, thus slightly compressing spring 58. In the event of any play in wheel 21, wheel 21 will move outwards and, when wear reaches a certain magnitude, a gap will open between end 55 of shaft 49 and the head of plug 57 through which air from duct 51 exits to the atmosphere through ports 6, as shown in FIG. 10A.

In the event of axle 49 being axially shifted outwards, end 55 of same will push head 62 of plug 57 against spring 58 until the seal ring 59 finally overtops and uncovers a port 77, as shown in FIG. 10B. Pressurized air in chamber 45 exits through this port 77, passing through the allowance between the head 62 of plug 57 and block 37 wall, and to vent port 65. As in the two other cases, pressurized air is vented and the driver is thus warned. The driver will then observe if the fault results from damage to the wheel bearings, a flat tire or worn rotor seals, thus preventing accidents.

An O-ring type seal ring 66 prevents foreign bodies from entering coupling 25 but gives way sufficiently to an internal overpressure to open vent 65. A separating seal 67 is located between the pair of bearings 47 to prevent, in the event of a leak in the solid seal, the passage of pressure to the bearing compartment, which may break the original seals.

A preferred embodiment of coupling 25′ is shown in FIG. 11. Coupling 25′ comprises a block 37 screwed onto an adjusting member 35 which in turn has an outer thread 41′ for attachment to the hub cap of a wheel. The thread 41′ of the support member 35 is shorter than in the first embodiment. A nut 75 is screwed onto the block 37 and tightened against support member 35 to clamp the block member 37 in position once it is properly adjusted, thus preventing the assembly 35-37, which integrally rotates with the wheel hub, from loosening.

A cover 53 screws onto the outer end of the block 37 thus forming a transfer chamber 45 therebetween. The cover is a plastic member in which side holes have been drilled forming inlets 43 to which pipes 27 linking tires 21 are connected. The cover may be replaced by means for attaching an odometer as illustrated in FIG. 9.

The block 37 is rotatably mounted around a shaft 49′ by means of a pair of ball bearings 47 protected by an outer seal 67′. The inner end of shaft 49′ of coupling 25′ has a widened section 61, provided with an O-ring 68, for closely fitting one end of a hose 71 and a circumpherential tooth 69′ which is useful for pulling the hose 71 out together with the coupling 25′ when the latter is dismantled from the wheel hub, so that it may be replaced if necessary and in any case not hamper maintenance work on the wheel hub.

An air duct 51 longitudinally traverses shaft 49 and continues through an extension plug 57 into the chamber 45, from where it is directed to the outlet ports 43 across the rotary coupling. A spring 58 pushes against a washer 84 to bias the extension 57 plug so that it sealingly abuts against the main shaft 49′ to thus prevent venting of pressurized air through the port 65 under normal operating conditions. A safety washer 63 is housed in a circumpherential groove in the shaft 49′ to hold the latter in place against the ball-bearings 47, preventing axial play of the shaft 49′. The plug extension 57 rotates integrally with the block 37 and against the outer end of the stationary shaft 49′.

As opposed to the embodiment of FIG. 8, the coupling 25′ offers several advantages in that its construction is simpler and it has a shorter shaft 49′ making it more compact. Compactness means that the coupling 25′ sticks out less from the side of the vehicle which makes it less prone to breakages when scraping by nearby moving or still objeects, in particular when negotiating narrow passages such as through a toll station. For instance, the coupling 25 of FIG. 8 may project between 62 and 87 mm from the wheel hub whereas the projection of the coupling 25′ of FIG. 11 may be reduced as much as down to 30 mm.

Moreover, the coupling 25′ is better leakproof since, by its construction, dirt is prevented from getting between the abutting ends of the hollow axle 49′ and the plug extension 57 which would be a potential source of air-leaks. In particular, when dismantling the coupling 25′ from the wheel hub, the shaft comes out together with the sealing means, thus preventing dirt from penetrating therebetween. On the other hand, the coupling 25′ may not used for monitoring excessive play and wear of the wheel components

A manner of mounting the coupling 25 or 25′ is depicted in FIG. 12. In order to cut the connecting hose to the proper length, the hub is placed and the distance from the cover to the end of the axial connector. This distance plus 4 mm is the length of hose that should be cut measured from the end of the coupling 25 or 25′. The hose is then oiled and fitted onto the coupler inside the axle. The coupling is pressed thereagainst and screwed until abutting against the counternut, which should be abutting against the coupling block. The coupling is then unscrewed about 2 to 25 turns and then the counternut is tightened.

It will be obvious to one skilled in the art that various changes and modifications may be made to the embodiment herein described, without departing from the spirit and scope of the invention.

What is claimed is:

1. In a vehicle having axles having two opposite ends, wheels mounted to the axle ends, a tire in each wheel and a pressure control system installed in the vehicle, a rotary pneumatic coupling for connecting at least a respective one or more of said tires to said pressure control system to control the air pressure inside said tire, said rotary pneumatic coupling comprising
a block mounted to the wheel,
a pressurized air chamber is formed inside said block and which is linked to said tire(s),
a rotary shaft located inside said block and axially traversed by a conduit operatively connecting said chamber to said air pressure control system; and
a rotary seal mechanism arranged between said block and said rotary coupling shaft to avoid, under normal operating conditions, any leak of pressurized air from said chamber connected to the axial conduit,
wherein said coupling shaft end is provided with a device for connection to a pressurized air duct passing through said vehicle axle to connect said chamber, through said conduit, to said pressure control system, and
wherein said block is provided with a vent port selectively communicated to said chamber and said axial conduit, said communication being normally closed by said rotary seal mechanism.

2. A coupling according to claim 1, wherein said block is rotatably mounted on said coupling shaft by means of a pair of ball bearings.

3. A coupling according to claim 2, wherein said coupling shaft is prevented from shifting axially relative to said ball bearings by a washer housed in a circumpherential groove thereof and abutting against said ball bearings.

4. A coupling according to claim 2, extending no more than 30 mm from said wheel.

5. A coupling according to claim 1, wherein said communication between said vent port and said chamber and axial conduit opens in response to a predetermined axial shift of said coupling shaft.

6. A coupling according to claim 1, wherein said rotary seal mechanism comprises a seal plug housed in said block and sealing said chamber, said seal plug having a longitudinal opening and said coupling shaft having an end abutting against said plug such that said seal opening is substantially aligned with said axial conduit of the coupling shaft.

7. A coupling according to claim 6, wherein said seal is movable relative to said block in the axial direction of said shaft and is provided with a seal ring sealing it against said block.

8. A coupling according to claim 6, wherein said rotary seal mechanism is provided with a spring seated on said block and stressing said seal longitudinally towards said coupling shaft.

9. A coupling according to claim 1, wherein said block comprises at least two members screwed onto each other such that one of them is fixed to the wheel axle end and the other one is axially adjustable relative to the first member, said block also comprising a lock nut capable of securing the axial position of said block's adjustable member.

10. In combination with a vehicle having a non-rotary axle having a hollow inside, a sidewall surrounding the hollow inside and an axle end to which said wheel is mounted, a tire inflation pressure control system located in a non-rotary part of the vehicle and comprising a pressurized air source, pipe means for communicating said source with said tire, means for detecting air pressure in the pipe means and a valve means for selectively opening communication between said tire and the source in response to a signal from the pressure detecting means indicating an air pressure requirement; wherein said pipe means comprises:
an external pipe extending from the control system to an intermediate point of said axle,
an internal tube laid along the hollow inside of the axle towards said axle end,
static coupler means located at said intermediate point of the axle for communicating said internal tube to said external pipe through said sidewall and
a rotary pneumatic coupling mounted to said axle end for communicating air between said second pipe means and said tire.

11. A control system according to claim 10, wherein said control system is located in a trailer of said motor vehicle, and said air pressure detecting means and said electrovalve of said system are housed in a control module including a panel provided with inflation status indicator lights, said control module being mounted on said trailer such that said panel is in the field of view of a driver's rear-view mirror.

12. A control system according to claim 11, wherein said indicator lights comprise for each axle a red light, a yellow light and a green light, the green light indicating that the tires maintain their adjustd pressure, the red light indicating low supply air pressure, the tires then being disconnected from the pressurized air supply until operating pressure is recovered, while the yellow light operates as a fault coder for the axle: intermittent flickering of the yellow light alone means a minor air leak in the tire, replenishable by the pressurized air supply; yellow light continuously on means a major air leak in the tire, replenishable for a short period by the pressurized air supply in order to repair the fault; and yellow light flickering alternately with the red light means an air leak in the tire exceeding any compensation by the pressurized air supply.

13. A control system according to claim 10, wherein said internal tube inncludes a connecting end projecting through said axle end and said rotary pneumatic coupling is connected to said internal tube by a flexible length of tubing plugged onto said projecting connecting end.

14. A control system according to claim 10, wherein said said rotary pneumatic coupling comprises:
a block mounted to the wheel,
a pressurized air chamber formed inside said block and linked to said tire,
a rotary shaft located inside said block and axially traversed by a conduit operatively connecting said chamber to said air pressure control system; and
a rotary seal mechanism arranged between said block and said rotary coupling shaft to avoid, under normal operating conditions, any leak of pressurized air from said chamber connected to the axial conduit,
said coupling shaft end provided with a device for connection to a pressurized air duct passing through said vehicle axle to connect said chamber, through said conduit, to said pressure control system, and
said block provided with a vent port selectively communicated to said chamber and said axial conduit, said communication being normally closed by said rotary seal mechanism.

15. A method for arranging a pressurized air duct inside a vehicle's hollow half-axle for connecting a wheel tire on an end of said half-axle to a tire inflation pressure control system located in a non-rotary part of the vehicle, said method comprising the steps of:
drilling holes in the end of the axle and in an intermediate side point of the axle;
laying an air tube between both holes;
placing a connector in said intermediate hole and connecting it to an end of said tube;
passing the other end of the tube through said hole drilled in the end of the axle and connecting it to the inner axle end of the rotary pneumatic coupling by screwing it into the first hole; and
connecting the pneumatic coupling system to said connector.

16. A method according to claim 15, wherein to lay said air tube inside the vehicle axle, an auxiliary tube is previously laid through said axle inside and said auxiliary tube is used as a guide for passing said air tube inside the vehicle axle.

17. A method according to claim 15, comprising the sep of forming a labyrinthine vent for an oil chamber housed in the axle end, extending it to said intermediate hole parallel to and outside of said conduit and said connector.

18. A method according to claim 15 for arranging an air duct inside a solid-end half-axle, comprising the steps of:
drilling the axle end;
performing cross drilling in the middle zone of the axle tube;
making a first centred thread in the axle end;
making a second thread in the middle zone of the axle tube;
protecting a polyamide tube with an hexagonal polyamide tube in the solid portion of the axle;
passing a through tube inside a straight copper pipe;
passing a through tube through the second hole;
inserting the straight copper pipe containing the final tube through the first threaded hole such that it is engaged by the through tube;
pulling the through tube outwards, drawing the final tube outwards through the second hole;
pulling the copper pipe out through the first hole, taking care not to remove the tube it housed;
connecting the end of this tube to the end of the Teflon tube by means of a straight connector;
placing a protective spring around said connector;
placing a coupling in the thread, turning the whole assembly to tighten it;
cutting the Teflon tube, leaving an end projecting out of the first hole;
placing a washer, a connector and a steel nipple in the second hole;
turning the spring to abut against the connector;
tightening the coupling against the axle;
connecting the pipe to the connector; and
coupling the inner end of the shaft of the rotary pneumatic coupling by screwing it into the first hole.

19. A method according to claim 15 for arranging an air duct inside a hollow-end half-axle, comprising the steps of:
making a first hole in the rear portion and in the middle of the axle using a magnetic drilling machine;
passing a long tube from end to end inside the axle;
inserting an unthreaded end of a Teflon tube inside the long tube;
screwing the short tube threaded end into the Teflon tube;
pushing this assembly inwards such that the connector's threaded orifice is directed towards the hole drilled in the axle;
inserting a stem through the latter hole;
screwing said stem into the connector orifice;
placing a straight connector in the stem;
manually screwing the straight connector into the internal connector;
removing the stem and tightening a lock nut until the internal connector is secured against the axle inner wall;
cutting the Teflon tube, leaving an end projecting out of the first hole in the axle end;
protecting the Teflon tube with helical tape;
connecting the coupling and inserting the whole assembly to abut against the plug;
drilling the plug with a drill bit, using the two orifices provided in the coupling as a guide;
riveting the coupling with the two orifices;
connecting the pipe to the connector; and
coupling the inner end of the shaft of a rotary pneumatic coupling by screwing it into the first hole.

20. A method according to claim 15 for arranging an air duct inside a half-axle having a hollow-end closed by an internal reinforcement, comprising the steps of:
placing a rivet with a first thread in the end plug and riveting it;
making a second thread in the rear portion of the axle;
protecting a Teflon tube with a hexagonal tube in the axle solid portion;
passing a tube, which will be the air duct inside the axle, inside a straight copper pipe;
placing a through tube through the second hole;
inserting the straight copper pipe containing the final tube through the first threaded hole such that it is engaged by the through tube;
pulling the through tube outwards, drawing the final tube outwards through the second hole;
pulling the copper pipe out through the first hole, taking care not to remove the tube it housed;
joining this tube end to the Teflon tube end by means of a straight connector;
placing a protective spring around this connector;
placing a coupling in the thread, by turning the whole assembly to tighten it;
cutting the Teflon tube, leaving an end projecting out of the first hole;
placing a washer, a connector and a steel nipple in the second hole;
turning the spring to abut against the connector;
tightening the coupling against the axle;
connecting the pipe to the connector; and
coupling the inner end of the shaft of a rotary pneumatic coupling by screwing it into the first hole.

21. A method for detecting a defective bearing in a wheel having a rotary pneumatic coupling according to claim 5, comprising detecting a pressurized air leak through said vent port as a any of result of wear, breakage and/or failure of bearings mounting the wheel on the vehicle axle, caused by a substantial axial shift of said axle in the inward direction.
